(19) United States
(12) Patent Application Publication
(10) Pub. No.: US 2004/0000231 A1
(43) Pub. Date: Jan. 1, 2004

(54) Composite gas separation membranes from perfluoropolymers

(76) Inventors: Benjamin Bikson, Brookline, MA (US); Yong Ding, Norwood, MA (US); Joyce Katz Nelson, Lexington, MA (US)

Correspondence Address: PRAXAIR, INC., LAW DEPARTMENT - M1 557, 39 OLD RIDGEBURY ROAD, DANBURY, CT, 06810-5113, US

(21) Appl. No.: 10/187,099

(22) Filed: Jul. 1, 2002

(51) Int. Cl. B01D 53/22

(52) U.S. Cl. 95/45; 95/50

(57) ABSTRACT

Improved composite gas separation membranes from perfluoropolymers are disclosed. The membranes are formed by depositing an ultrathin, dense separation layer of a soluble amorphous perfluoropolymer on top of a porous polyethersulfone substrate. The membranes are particularly useful for the separation and recovery of volatile organic hydrocarbon vapors.

### BACKGROUND OF THE INVENTION

Composite membranes capable of selectively permeating one component of a gas mixture over the remaining components in the mixture generally include a thin selective layer or coating of a suitable semipermeable membrane material superimposed on a porous substrate. Generally, while the coating affects the separation characteristics of the composite membrane, the primary function of the substrate is to provide support for the selective layer positioned thereon. Common porous substrates are configured as flat-sheet membranes or as hollow fibers. In commercial or industrial applications, composite membranes need to operate for extended periods with a low incidence of failure. Furthermore, the membranes must often operate in fouling or corrosive environments. For such applications, perfluoropolymers have been proposed as superior membrane forming materials.

A number of perfluorinated polymers have been disclosed in the art as materials for gas separation applications. U.S. Pat. Nos. 4,897,457 and 4,910,276 disclose the use of perfluorinated polymers having repeat units of perfluorinated cylic ethers and report gas permeation properties for a number of polymers. U.S. Pat. No. 5,051,114 disclose gas separation processes employing 2,2-bis(trifluoromethyl)-4,5-difluoro-1,3-dioxole-based (BDD) polymer membranes. European Patent Application 1,163,949 A2 discloses preparation of improved gas separation membranes from soluble perfluoropolymers, such as perfluoromethoxydioxole and perfluoro-2,2-dimethyl-1,3-dioxole copolymers. U.S. Pat. No. 6,361,582 discloses the use of perfluorinated polymers with fractional free volume below 0.3 for hydrocarbon separation applications.

U.S. Pat. No. 6,316,684 discloses improved membranes for hydrocarbon separations, including perfluorinated polymer-based membranes that contain dispersion of fine nonporous particles, such as silica or carbon black particles, having an average diameter not greater than about 1,000 Å.

V. Arcella et al. in an article entitled “Study on Perfluoropolymer Purification and its Application to Membrane Formation”, Journal of Membrane Science, Vol. 163, 203-209 (1999), reported the use of copolymers of 2,2,4-trifluoro-5-trifluoromethyoxy-1,3-dioxide (TTD) and tetrafluoroethylene (TFE), Hyflon® AD60X, and Hyflon® AD80X as membrane forming materials.

European Patent Applications 969,025 and 1,057,521 disclose preparation of nonporous and porous membranes prepared from amorphous perfluoropolymers.

U.S. Pat. No. 6,406,517 discloses the preparation of permeable membranes from a perfluoropolymer wherein the gas separation selectivity can be increased by blending the perfluoropolymer with a nonpolymeric fluorinated adjuvant.

To be useful in commercial gas separation applications, perfluorinated polymers must be formed into a membrane with a nonporous ultrathin separation layer; the composite configuration being the preferred membrane configuration.

Several processes for making composite membranes are known in the art.

U.S. Pat. No. 4,840,819 discloses a process in which a dilute solution of permeable polymer is applied to a porous substrate having a controlled amount of liquid incorporated therein.

U.S. Pat. No. 4,806,189 discloses a process for producing a composite fluid separation membrane by in situ formation of a separation layer on a porous support wherein the pores of the support are pre-impregnated with a solvent.

U.S. Pat. No. 5,320,754 discloses preparation of composite membranes by applying perfluoroethers to the surface of a porous substrate prior to coating with a selective polymeric material to form a separation layer.

U.S. Pat. No. 5,213,689 discloses a method of coating microporous polyolefin hollow fibers by wet spinning or by dry-wet spinning. Polyolefin hollow fibers are coated with a solution of a polyimide polymer containing perfluoro groups. The polyolefin hollow fiber is optionally pre-wetted with glycerin prior to coating.

Several amorphous perfluoropolymers have been used as coating or membrane materials, including perfluoropolymers with high gas permeation characteristics.

U.S. Pat. No. 5,051,114 discloses amorphous perfluoro-2,2-dimethyl-1,3-dioxole-based polymers that can be used for several separation and gas enrichment applications, including oxygen enrichment of air.

U.S. Pat. No. 4,754,009 discloses a gas permeable material that contains passageways wherein the interior of the passageways is formed by solution coating of perfluoro-2,2-dimethyl-1,3-dioxole.

U.S. Pat. No. 5,876,604 discloses preparation of composite perfluoro-2,2-dimethyl-1,3-dioxole membranes that can be used to add a gas to a liquid or to remove a gas from a liquid. The membranes exhibit resistance to fouling by liquids and can be utilized for ozorrolysis or oxygenation.

U.S. Pat. No. 5,914,154 discloses preparation of nonporous gas permeable membranes by flowing a dilute coating solution of perfluoropolymer through one side of a microporous substrate until the desired thickness of coating polymer has been built up; the solution is then removed and residual solvent is evaporated.

Composite perfluoropolymer membranes produced utilizing a conventional porous substrate, such as a polysulfone substrate, can exhibit inferior gas separation properties in feed streams that contain high concentrations of hydrocarbon vapors. Thus the need still exists for an improved perfluoropolymer composite membrane for separation of volatile hydrocarbons from fast gas permeating components.

### SUMMARY OF THE INVENTION

The instant invention is directed to preparation of improved composite perfluoropolymer membranes that are particularly useful in separating C₃ and higher molecular weight hydrocarbon vapors from fast gas permeating components, such as hydrogen, oxygen, nitrogen carbon dioxide or methane. It was found surprisingly that composite perfluoropolymer membranes with an improved combination of gas separation/permeation characteristics are formed by utilizing certain polymers, such as polyethersulfone, as a porous substrate for composite membrane preparation.

The invention is generally directed to composite membranes, devices including the composite membranes, and to methods of producing the composite membranes based on an amorphous soluble perfluoropolymer separation layer and a polyethersulfone porous substrate. The invention is also directed to methods of separating a gas mixture into a fraction enriched in a volatile hydrocarbon component and a fraction depleted in that volatile hydrocarbon component. In one preferred embodiment, the gas mixture is air containing volatile organic compounds (VOCs) the fraction depleted of VOC being the oxygen enriched air and the fraction enriched with VOC being the nitrogen enriched air.

In one preferred embodiment, the invention is directed to a composite membrane that includes a porous asymmetric hollow fiber substrate formed from polyethersulfone, having an inner or bore side surface and an outer surface, and a perfluorinated polymer coating applied to the outer surface.

In another preferred embodiment, the invention is directed to a composite membrane having a nitrogen permeance of at least 200 GPU and a nitrogen/propane gas separation factor of at least 11.0, where 1 GPU is 1×10⁻⁶ cm³ (STP)/cm²·sec·cmHg.

In a preferred method of forming composite membranes of this invention, the composite membrane is formed by a process comprising the steps of impregnating an asymmetric polyethersulfone porous hollow fiber substrate with an impregnation fluid that is immiscible with the perfluorinated solvent of the coating solution, coating the impregnated substrate with the solution that includes the perfluorinated polymer and the perfluorinated solvent, and removing the perfluorinated solvent and the impregnation fluid by evaporation.

The composite membranes of the invention are capable of withstanding environments that contain high concentrations of hydrocarbon vapor, such as, for example, air streams containing volatile organic hydrocarbons, and are effective in separating these hydrocarbon vapors from fast gas permeating molecules that typically have a kinetic diameter of about 3.9 Å and less. Since the determination of kinetic sieving diameters of gas may vary, this invention references the diameters listed by D. W. Breck in “Zeolite Molecular Sieves”, 1994. The volatile organic hydrocarbons are C₃ and higher molecular weight hydrocarbons, such as propane, butane, pentane, etc., unsaturated hydrocarbons, ketones, alcohols, and the like.

### DETAILED DESCRIPTION OF THIS INVENTION

The features and other details of the invention, either as steps of the invention or as combination of parts of the invention, will now be more particularly described and exemplified. It should be understood that the particular embodiments of the invention are shown by way of illustration and in no way limit the scopes of the invention. The principle feature of this invention may be employed in various embodiments without departing from the scope of the invention. The invention is related to composite perfluoropolymer gas separation membranes, to devices including the composite membranes, and to methods of producing the composite membranes. The invention is also related to methods for separating a gas mixture into a fraction enriched in a fast permeating component and a fraction depleted in the fast permeating component.

It has been discovered that composite perfluoropolymer membranes formed on polyethersulfone porous substrates exhibit a superior combination of gas separation/permeation characteristics, in particular, for separation of VOC (volatile organic compound, typically hydrocarbon) vapors from VOC-containing gas streams, as compared to composite perfluoropolymer membranes formed on a conventional porous substrate made from other polymers such as the polysulfone.

The porous support or substrate can be in the form of a flat sheet or in a hollow fiber configuration. The hollow fiber configuration is preferred. Techniques for preparing a polyethersulfone hollow fiber substrate include wet spinning, dry spinning, dry-wet spinning, and other methods known in the art. Techniques useful in preparing a porous hollow fiber substrate are described, for example, by I. Cabasso in Hollow Fiber Membranes, Kirk Othlmer Encyclopedia Chem. Tech., 12, Third Ed., pp. 492-517 (1980). In a preferred embodiment of the invention, the substrate is prepared by a dry-wet spinning process such as that disclosed in U.S. Pat. No. 5,181,940, issued on Jan. 26, 1993 to Bikson, et al. and U.S. Pat. No. 5,871,680 issued on Feb. 16, 1999 to Macheras, et al.

Generally, the hollow fiber substrate has an outer diameter that ranges between about 100 microns (μm) and about 2,000 μm. Substrates having an outside diameter between about 300 μm and about 1500 μm are preferred. Generally, the inner or bore diameter of the substrate is about 50 to 90 percent (%) of its outer diameter. The substrate has a wall thickness that ranges from about 30 μm to about 400 μm. A wall thickness no greater than about 300 μm is preferred.

Preferably, the substrate provides little resistance to gas flow. In one embodiment of the invention, the substrate contains pores that occupy at least 25%, preferably at least 50%, of the wall volume. The average cross-sectional diameter of the pores present in the substrate generally ranges from about 100 angstroms to about 200,000 angstroms. The terms “average cross-sectional diameter”, “average diameter” and “pore diameter” are used herein interchangeably. Average diameters can be determined experimentally as known in the art, for example by adsorption techniques and by scanning electron microscopy.

Substrates can be symmetrical, having essentially uniform pore structure characteristics, for instance, having uniform average cross sectional pore diameter throughout the thickness of the substrate, or they can be asymmetrical. As used herein, the term “asymmetrical” refers to substrates that do not have the same pore structure throughout the substrate thickness; the structure being determined, for instance, by variations in the shape or average cross-sectional diameter of the pores. In one embodiment the average pore diameter of the asymmetric substrate is a graded, progressing from one average pore diameter at a first surface to a smaller average pore diameter at a second surface of the substrate wall.

In a preferred embodiment of the invention, the substrate is an asymmetric porous hollow fiber. The substrate has a bore defining an inner surface and an outer surface, and includes an interior region extending from a region adjacent to the bore to a surface region adjacent to the outer surface. Both the interior region and the surface layer are porous. In a preferred embodiment of the invention, the pore structure characteristics of the interior region differs from the pore structure characteristics of the outer surface or surface region. In another preferred embodiment, the average pore diameter in the interior region, referred to herein as interior pores, is at least about 10 times larger than that of pores in the surface layer, referred to herein as surface pores.

In one embodiment of the invention, surface pores have an average diameter of less than about 1,000 angstroms. In another embodiment of the invention, surface pores have an average diameter that is less than about 500 angstroms.

Configurations in which the interior region extends through most of the wall thickness of the substrate combined with a relatively thin surface layer are preferred. In one embodiment of the invention, the thickness of the surface region is no greater than about 1,000 angstroms. High levels of surface porosity are preferred. In one embodiment the ratio of the area occupied by surface pores to the total surface area is greater than 5×10⁻³. In another embodiment the ratio is greater than 2×10⁻². Surface pores having a narrow pore size distribution also are preferred.

Alternatively, or in addition to the features discussed above, the substrate can be characterized by its gas separation factor and gas permeance. The gas separation factor between two gases is defined as the ratio of their respective gas permeances. The gas permeance is defined as the reduced permeability (Pₐ/□) of a membrane of thickness □ wherein the permeability for a given gas through a homogeneous dense material is the volume of the gas at a standard temperature and pressure (STP), which passes through a square centimeter of the membrane surface area, per second, at a partial pressure differential of 1 centimeter of mercury across the membrane per centimeter of thickness, and is expressed as P=cm³ (STP) cm/[(cm²) (sec) (cmHg)].

In one embodiment of the invention, the porous substrate exhibits a helium permeance of above 1×10⁻² cm³ (STP)/[(cm²) (sec)(cmHg)] combined with a He/N₂ separation factor that is at least 1.5 and preferably at least 1.9. The gas separation is believed to be primarily generated by the Knudsen flow in the surface pores.

The composite membrane of this invention includes a perfluoropolymer gas separation layer, also referred to herein as a perfluorinated polymer layer, superimposed on the polyethersulfone porous support. Amorphous perfluorinated polymers are preferred. Also preferred are perfluoropolymers that exhibit gas permeability coefficients greater than 30 barrers, preferably greater than 100 barrers for the fast gas transported across the membrane. (1 Barrer=10¹⁰ cm³(STP) cm/cm²·cmHg·sec).

Specific examples of suitable materials that can be employed in making the perfluorinated polymer separation layer include amorphous copolymers of perfluorinated dioxoles such as those described in U.S. Pat. No. 5,646,223, issued on Jul. 8, 1997 to Navarrini, et al. In one embodiment of the invention, the perfluoropolymer includes either a pefluoromethoxydioxole or a perfluro-2,2-dimethyl-1,3-dioxole-based polymer. The most preferred polymers are amorphous copolymers of perfluoro-2,2-dimethyl-1,3-dioxole (PDD) such as those described in U.S. Pat. Nos. 5,051,114 and 4,754,009. These include copolymers of PDD with at least one monomer selected from the group consisting of tetrafluoroethylene (TFE), perfluoromethyl vinyl ether, vinylidene fluoride and chlorotrifluoroethylene. In one most preferred embodiment the copolymer is a dipolymer of PDD and TFE wherein the copolymer contains 50-95 mole percent of PDD. Blends of perfluoro-2,2-dimethyl-1,3-dioxole-based polymers with 2,2,4-trifluoro-5-trimethoxy-1,3-dioxide-based polymers are also preferred.

A composite membrane having a separation layer formed from perfluoro-2,2-dimethyl-1,3-dioxole copolymers supported on a polyethersulfone substrate is particularly preferred.

Preferably, the separation layer is supported on the outer surface of the substrate. In embodiments in which the asymmetric porous substrate has a shape other than that of a hollow fiber, the separation layer is preferably supported on the surface having the smaller average cross sectional pore diameter.

A thin separation layer is preferred. Generally, the separating layer is less than about 1 μm thick, preferably less than about 0.5 μm thick. Separation layers that have a thickness of about 1000 angstroms or less are even more preferred (wherein 1 Å=1×10⁻¹⁰ m). Particularly preferred are separation layers that have a thickness between about 300 angstroms and about 500 angstroms.

Preferably, the separation layer is also substantially free of defects. By defects it is meant cracks, holes and other irregularities introduced by coating the perfluorinated polymer onto the substrate to form the separation layer. The term “substantially free of defects” means that the gas separation factor of the composite membrane is at least about 75 percent of the measured gas separation factor of the a dense homogeneous film of perfluoro-polymer coating material. In a preferred embodiment, the gas separation factor of the composite membrane is at least about 95% of the measured gas separation factor of the perfluoro-polymer coating material.

Alternatively or in addition to the features discussed above, the composite membranes of the invention can be characterized by their permeance and by their gas separation factor. In one embodiment of the invention, the nitrogen permeance of the composite membranes of the invention is at least about 100×10⁻⁶ cm³ (STP)/[cm²(sec)(cmHg)] and preferably at least about 300×10⁻⁶ cm³ (STP)/[cm² (sec)(cmHg)]. In another embodiment, the composite membrane exhibits a nitrogen/propane (N₂/C₃H₈) gas separation factor of at least about 8.0, preferably at least 11.0, as determined by pure gas permeability measurements.

The invention also relates to a method for producing a composite membrane. In a preferred embodiment the method includes impregnating the porous polyethersulfone support with an impregnation fluid, coating the impregnated substrate with a solution of perfluorinated polymer in a perfluorinated solvent and evaporating the perfluorinated solvent and the impregnating fluid to form a solidified perfluorinated polymer layer on the porous support. Preferred impregnation fluids include liquids having a boiling temperature between about 60° C. and about 150° C. Suitable impregnation fluids include water and volatile liquids that are essentially insoluble in the coating solution. Specific examples of suitable impregnation fluids include: C₆ to C₁₀ hydrocarbons, for instance, cyclohexane and heptane; alcohols, for instance, ethanol, isopropyl alcohol, n-butanol; and any combination thereof. Water is the preferred impregnation fluid.

The amount of the impregnation fluid present in the porous structure of the substrate can depend on the morphology of the porous substrate. As used herein, “level of impregnation” means the fraction of the pore volume occupied by the impregnation liquid. High levels of impregnation generally are preferred. However, excessive amounts of impregnation, wherein the outer surface of the porous substrate is completely covered by the impregnation liquid, can prevent the uniform wetting out of the surface of the porous support by the coating solution, and this in turn may result in nonuniform coating.

The amount of impregnation fluid present in the porous substrate can be controlled. In one embodiment of the invention, the impregnation fluid is at least partially removed from the porous substrate, for example, by passing it through a drying oven. The oven temperature, oven air circulation rate and the speed with which the porous substrate is conveyed through the oven can be adjusted to control the uniformity and the level of impregnation. The porous substrate that is impregnated with the impregnation fluid and, optionally, pre-dried to partially remove impregnation fluid from its porous structure, is coated with the perfluorinated polymer solution. The coating can be at one or both sides of a planar substrate. In the case of hollow fiber substrates, the coating can be at the bore side, outer surface or both.

The coating solution includes a perfluorinated polymer, such as, for example, the perfluopolymers described above, and a perfluorinated solvent. Perfluorinated and quasi-perfluorinated solvents, which also are referred to herein as “perfluorinated”, are preferred. Suitable solvents include, but are not limited to perfluoro (alkylamines), such as Fluorinert™ FC-40 from 3M, perfluorotetrahydro-furans, such as Fluorinert ™ FC-75 from 3M, perfluoropolyethers, such as Galden® HT 90, Galden® HT110 and Galden® HT-135 from Ausimont, and others.

The concentration of perfluoropolymer coating solutions is preferably below 3 grams (g)/100 cubic centimeters (cm³), more preferably below 2 g/100 cm³ and most preferably below 1 g/100 cm³.

The miscibility of the impregnation fluid in the solvent employed in the coating step preferably does not exceed about 15% by volume at room temperature conditions, i.e. 20° C. More preferably the miscibility is less than about 5% by volume at room temperature. In one embodiment of the invention, the impregnation fluid is essentially immiscible with the solvent. By the term “essentially immiscible” it is meant that the rate of penetration of the solvent into the impregnation fluid is so slow as to limit occlusion of the solution into the porous substrate until the coating has solidified.

The porous substrate impregnated with impregnation fluid, can be coated with the solution of the perfluoropolymer in the perfluorinated solvent in a coating and drying sequence. This coating and drying sequence includes passing the hollow fiber through the coating solution contained in a coating vessel or through a coating applicator followed by drying in an oven prior to the fiber being taken up on a winder or otherwise being processed or stored for eventual incorporation into modules suitable for commercial gas separation applications.

Examples of an apparatus suitable for hollow fiber coating operations are known in the art and described in U.S. Pat. No. 4,467,001 and European Patent Application EP 719581. As discussed above, the coating and drying sequence can be preceded by partial pre-drying of the impregnated substrate.

In a preferred embodiment a porous polyethersuflone hollow fiber substrate is formed by a dry-wet spinning process, the hollow fiber substrate is washed to remove residual solvent and pore former, the hollow fiber substrate is partially dried to remove the surface layer of the washing liquid, the hollow fiber substrate is coated with a dilute solution of amorphous perfluoropolymer in perfluorinated solvent and dried.

The mechanism that leads to the formation of the improved composite membranes of this invention is not fully understood. However, without wishing to be bound by the exact mechanism of composite membrane formation, it is believed that the unique performance of the membranes disclosed herein can be at least partially attributed to the ability of the support substrate to retain a stable porous configuration in the presence of volatile organic hydrocarbons. This support layer characteristic is important to sustaining a defect-free separation layer. The support layer can further affect the physical characteristics of the ultrathin separation layer by reducing its susceptibility to swelling by VOCs.

The membrane of the invention can be employed in processes for separating a gas mixture into a fraction enriched in a fast permeating component and a fraction depleted in that component. Specific examples of gas mixtures include, but are not limited to, air, natural gas and hydrogen-based gas streams that contain volatile organic hydrocarbons, (VOCs), and hydrocarbon gas mixtures. In a preferred embodiment the gas mixture is air containing VOC and the fast permeating components are oxygen and nitrogen.

Generally, to affect the separation, the gas mixture is contacted with a composite hollow fiber membrane under conditions of a pressure differential across the membrane. Membrane system configurations having a bore side feed, as well as configurations having a shell side feed, can be employed, as known in the art. A portion of the gas mixture preferentially permeates through the composite membrane under a partial pressure-driving force for each gas, thereby generating a fraction enriched in the fast permeating component and a fraction depleted in that component.

The invention relates also to separation devices, and especially to gas separation devices, also referred to herein as separation cartridges or separation modules. In a preferred embodiment, the separation device includes a substrate constructed from polyethersulfone hollow fibers and coated with perfluoro-2,2-dimethyl-1,3-dioxole copolymers. The separation modules of the present invention can be utilized in gas separation processes such as removal of volatile organic carbon compounds, such as hydrocarbons from air methane or hydrogen containing streams.

The invention is further described through the following examples that are provided for illustrative purposes and are not intended to be limiting.

### Preparative Example 1

Preparation of Porous Polyethersulfone Hollow Fiber Substrate

A porous polyethersulfone hollow fiber substrate was prepared by a dry-wet spinning process from the following spinning solution: 34 wt % polyethersulfone Ultrason 3010, 33% Triton X-100 and 33% N-methyl pyrrolidone (NMP). The prefiltered polyethersulfone solution was spun through a tube-in-orifice spinneret to produce the nascent hollow fiber. The spinneret was completely enclosed in a vacuum chamber in which the vacuum level was maintained at about 14 cm Hg. The spinning dope was extruded through the spinneret at a temperature of 49° C. while water was delivered through the bore of the injection tube to produce a hollow filament stream in the vacuum chamber. The hollow filament stream traveled through the vacuum chamber for a distance of about 20 cm and was then coagulated in water maintained at about 45° C. and collected at a rate of about 30 meters per minute. The hollow fiber dimensions were about 0.075 cm outer diameter (OD) and 0.043 cm inner diameter (ID). The thus formed hollow fibers were first washed extensively with an isopropyl alcohol/water mixture (80/20 by volume) and then with a large excess of water. The hollow fibers were stored wet until their further use as a substrate in forming composite membranes. When dried, the hollow fibers had a helium permeance of 2.35·10⁻² cm³ (STP)/cm²·sec□cmHg and a N₂ permeance of 1.08×10⁻² cm³ (STP)/cm²□sec□cmHg with a selectivity of. 2.18 for He/N₂.

### EXAMPLE 1

Preparation of Composite Perfluoropolymer Membrane Utilizing the Polyethersulfone Hollow Fiber Substrate.

The composite membrane was fabricated by coating the porous polyethersulfone hollow fiber substrate prepared as described in Preparative Example 1 with a solution of Teflon® AF 1600 polymer (Du Pont) in Fluorinert™ −75 (3M) solvent. The polymer concentration in the coating solution was 0.75 g/100 cm³. The water saturated polyethersulfone hollow fibers were partially pre-dried by passing through a drying oven maintained at 160° C. The pre-dried polyethersulfone hollow fibers were coated by transporting the fibers through a coating solution, followed by drying in a second drying oven and then collected on a winder.

The thus prepared composite hollow fibers were constructed into separation modules and tested for gas permeation performances at 25° C. with pure gases. The feed pressure of the gas was 2.3 bar, except for propane which was 1.6 bar. The pressure normalized flux and gas separation factors are listed in Table 1.

### Comparative example 2

Preparation of Composite Perfluoropolymer Membrane Utilizing Polysulfone Hollow Fiber Substrate.

Composite membrane was fabricated following the same procedure as described in Example 1 except that a polysulfone hollow fiber substrate was used instead of the polyethersulfone hollow fiber. The thus prepared composite hollow fibers were constructed into separation modules and tested for gas permeation performances at 25° C. with pure gases. The feed pressure of the gas was 2.3 bar, except for propane which was 1.6 bar. The pressure normalized flux and gas separation factors are listed in Table 1.

TABLE 1

| | Pure gas pressure | | | | |
|---|---|---|---|---|---|
| | normalized Flux (GPU)* | | | Selectivity | |
| Example No | O₂ | N₂ | C₃H₈ | α(O₂/N₂) | α(N₂/C₃H₈) |
| 1 | 1235 | 547 | 46 | 2.3 | 12.1 |
| 2 (comparative) | 1175 | 490 | 76 | 2.4 | 6.4 |

*1GPU = 1 × 10⁻⁶ cm³ (STP)/cm².s.cmHg.

Equivalents

Those skilled in the art will recognize, or be able to ascertain using no more than routine experimentation, many equivalents to the specific embodiments of the invention described specifically herein. Such equivalents are intended to be encompassed in the scope of the following claims.

The term “comprising” is used herein as meaning “including but not limited to”, that is, as specifying the presence of stated features, integers, steps or components as referred to in the claims, but not precluding the presence or addition of one or more other features, integers, steps, components, or groups thereof.

Specific features of the invention are illustrated the specification for convenience only, as each feature may be combined with other features in accordance with the invention. Alternative embodiments will be recognized by those skilled in the art and are intended to be included within the scope of the claims.

What is claimed is:

1. A process for separating a fast permeating gas from a mixture containing a volatile organic hydrocarbon (VOC), the process comprising the steps of (a) bringing said gaseous mixture into contact with a feed side of a composite gas separation membrane; (b) providing a partial pressure differential between the feed side of the membrane and a permeate side of the membrane, such that a portion of said gas mixture permeates through the membrane; (c) collecting a portion of said gas mixture as a permeate gas, said permeate gas being enriched in the fast gas component and depleted in the volatile organic hydrocarbon; and (d) collecting a portion of said gas mixture as a nonpermeate gas wherein said nonpermeate gas is depleted in the fast gas component and enriched in the volatile organic hydrocarbon, wherein said composite gas separation membrane has a selective layer formed from a perfluopolymer and a porous support formed from a polyethersulfone.

2. The process of claim 1 wherein said composite membrane has a planar configuration.

3. The process of claim 1 wherein the said composite membrane has a hollow fiber configuration.

4. The process of claim 1 wherein said composite membrane has been formed by a method including the steps of:
a) impregnating said porous polyethersulfone support with an impregnation fluid that is essentially immiscible with a perfluorinated solvent;
b) coating the impregnated porous substrate with a solution that includes said perfluoropolymer and the perfluorinated solvent; and
c) removing said perfluorinated solvent and the impregnation fluid to form said perfluorinated polymer layer on said porous support, thereby forming said composite membrane.

5. The process of claim 4 wherein the porous substrate of said composite membrane is a hollow fiber having an inner surface defined by the bore of the fiber, and an outer surface wherein the perfluopolymer layer is on either the bore side or the outer surface of said hollow fiber.

6. The process of claim 5 wherein said feed side of the membrane is the hollow fiber bore.

7. The process of claim 1 wherein said porous support is asymmetric.

8. The process of claim 1 wherein the gas mixture is air.

9. The process of claim 8 wherein the fast gas component includes oxygen and nitrogen.

10. The process of claim 1 wherein said fast gas is hydrogen

11. The process of claim 1 wherein said fast gas is carbon dioxide.

12. The process of claim 1 wherein the perfluoropolymer includes either a perfluoromethoxydioxole-based polymer or a perfluoro-2,2-dimethyl-1,3-dioxole-based polymer.

13. The process of claim 1 wherein the perfluoropolymer is a blend of the perfluoromethoxydioxole-based polymer and the perfluoro-2,2-dimethyl-1,3-dioxole-based polymer.

14. The process of claim 12 wherein the perfluropolymer includes a copolymer of perfluoro-2,2-dimethyl-1,3-dioxole.

15. The process of claim 14 wherein the perfluoropolymer includes a copolymer of perfluoro-2,2-dimethyl-1,2-dioxole and tetrafluoroethylene.

16. The process of claim 4 wherein the impregnation fluid is selected from the group consisting of a hydrocarbon, an alcohol, water and any mixture thereof.

17. The process of claim 12 wherein the impregnation fluid is water.

18. The process of claim 2 wherein the perfluorinated solvent is selected from the group consisting of perfluoropolyethers, perfluoroalkylamines perfluorotetrahydrofurans and mixtures thereof.

19. The process of claim 14 wherein the perfluorinated solvent is perfluoro-n-butyl tetrahydrofuran.

20. The process of claim 1 wherein the porous support has a helium permeance that is at least about 1×10⁻² cm³ (STP)/cm²·sec·cmHg and a helium/nitrogen separation factor of at least about 1.9.

21. The process of claim 1 wherein said composite membrane has a nitrogen permeance of at least about 100×10⁻⁶ cm³(STP)/cm²·sec·cmHg and a nitrogen/propane gas separation factor of at least 11.

22. The process of claim 2 wherein the impregnation fluid is at least partially removed from the impregnated porous substrate prior to coating.

23. The process of claim 1 wherein said volatile organic hydrocarbon contains three or more carbon atoms.
